(19) United States
(12) Patent Application Publication
(10) Pub. No.: US 2003/0167321 A1
(43) Pub. Date: Sep. 4, 2003

(54) System and method for optimal setting of message acceptance filters

(75) Inventor: William A. White, Carlisle, MA (US)

Correspondence Address: Larry I. Golden, Square D Company, 1415 South Roselle Road, Palatine, IL, 60067, US

(73) Assignee: Schneider Automation Inc.

(21) Appl. No.: 10/086,474

(22) Filed: Mar. 1, 2002

(51) Int. Cl. G06F 15/173; G06F 15/16

(52) U.S. Cl. 709/223; 709/246

(57) ABSTRACT

A method for optimizing communication in a network involving wanted and unwanted network messages wherein a set of filters are configured to accept all wanted network messages and minimize the acceptance of unwanted messages in accordance with a selection criteria. A first filter is configured to receive all wanted messages. The first filter includes a defined bit and an undefined bit. Each defined bit is either in a first state or in a second state. A second filter is set equal to the first filter. The first filter and the second filter compose a first set of filters. Potential configurations of the first set of filters are determined wherein each potential configuration is capable of accepting all wanted network messages. The potential configurations are optimized wherein the optimized configuration ensures acceptance of all wanted messages and reduces the amount of accepted unwanted messages. A desired configuration for the filter set is chosen from the potential configurations based upon a selection criteria.

### TECHNICAL FIELD

The present invention relates generally to the field of network communication. More specifically, the present invention relates to systems that utilize mask/value filters to specify acceptance parameters wherein messages are accepted based on an identifying number contained in the message.

### BACKGROUND OF THE INVENTION

Network communication exists in various forms. One specific form is to utilize message accept/reject filters. In such a system, messages are accepted or rejected based on an identifying number contained in the message that matches (accept) or does not match (reject) a mask or value filter.

Devices connected within a communication network utilizing message acceptance filters will facilitate communication among each other by including a message identifier within each transmitted message. From the device perspective, the message identifier determines whether or not an incoming message is addressed to it. If so, the device will accept/filter the message and process the data. If not, the message will be rejected.

Filtering of the message can generally be accomplished in a variety of ways. In one technique, the module can either refuse the unwanted messages by implementing hardware filters. In another technique, all the wanted messages are initially accepted and then the unwanted messages are rejected via a software filtering process.

Software filtering has at least two drawbacks. One of which is a possible overload of the input buffers in the device. Another software shortcoming is the supplementary CPU activity required in such filtering. Hardware filters can also consume a great amount of time and CPU capacity.

Generally, message identifiers are chosen such that the filter can be chosen simply. However in some cases, e.g., ST7 microprocessors, the message identifiers and the filters have been prescribed and are not capable of being modified. In such a inflexible network, it is desirable to create a system capable of accepting all desired messages and rejecting the optimal amount of unwanted messages.

This invention is designed to solve these and other problems.

### SUMMARY OF THE INVENTION

The present invention is directed to a method for improving network communication utilizing acceptance filters. More specifically, one embodiment of the present invention provides a method for optimizing communication in a network. Communication on the network involves wanted and unwanted messages wherein a set of filters are configured to accept all wanted network messages and minimize the acceptance of unwanted messages in accordance with a selection criteria. The method comprises configuring a first filter to receive all wanted messages. The first filter includes a defined bit and an undefined bit. Each defined bit is either in a first state or in a second state. A second filter is set equal to the first filter. The first filter and the second filter compose a first set of filters. Potential configurations of the first set of filters are determined wherein each potential configuration of the first set of filters is capable of accepting all wanted network messages. Each potential configuration of the first set of filters is optimized to reduce acceptance of unwanted messages while continuing to ensure acceptance of all wanted messages.

A further aspect of the present invention includes selecting an optimum configuration of the first set of filters in response to a selection criteria. The optimum configuration of the first set of filters is selected from the potential configurations of the first set of filters.

An object of the present invention is to provide a method of improving the efficiency of hardware filters and reduce the accompanying complexity to set them.

Another object of the present invention is to determine the optimal configuration of a message acceptance filter for improving network communication.

Yet another object of the present invention is to provide a method of facilitating communication among operably connected devices on a network having prescribed and fixed message identifiers.

Other features and advantages of the invention, which are believed to be novel and nonobvious, will be apparent from the following specification taken in conjunction with the accompanying drawings in which there is shown a preferred embodiment of the invention. Reference is made to the claims for interpreting the full scope of the invention which is not necessarily represented by such embodiment.

### BRIEF DESCRIPTION OF THE DRAWINGS

FIG. 1 is a block diagram of a communication network;

FIG. 2 is a lock diagram of the internals structure of a device connected to the communication network; and,

FIG. 3 is a block diagram of the filter structure of one embodiment of the present invention.

### DETAILED DESCRIPTION

Although this invention is susceptible to embodiments of many different forms, a preferred embodiment will be described and illustrated in detail herein. The present disclosure exemplifies the principles of the invention and is not to be considered a limit to the broader aspects of the invention to the particular embodiment as described.

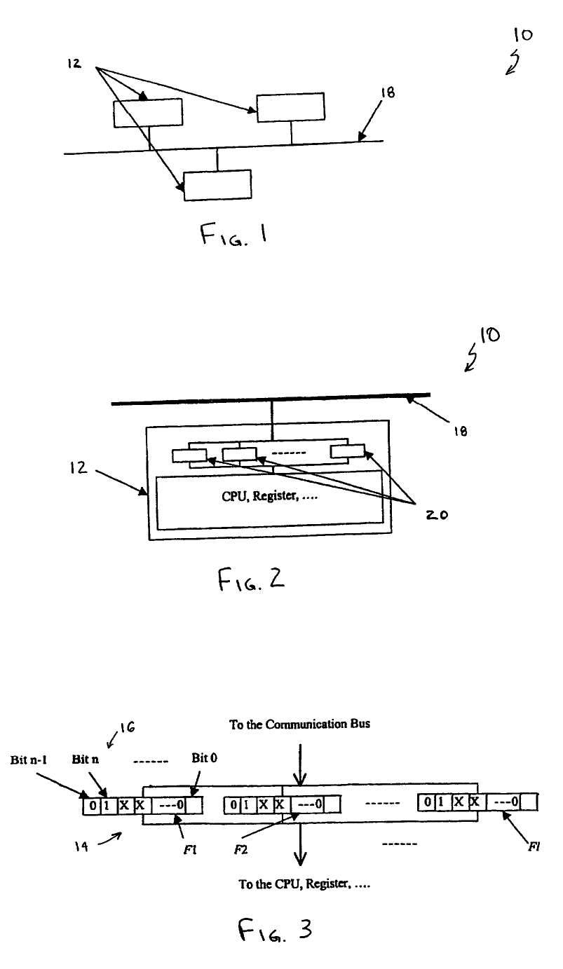

Referring to FIGS. 1 and 2, devices 12 on a network 10 communicate with each other by sending messages 14 having a message identifier 16 over a communication bus 18. From the perspective of each device 12, the message identifier 16 determines whether or not an incoming message is addressed to the device. If so, the device 12 will filter/accept the message and process the accompanying data. If not, the message will not be accepted.

The acceptance of the message 14 is accomplished through filtering. One filtering technique utilizes hardware filters to reject an unwanted message. Another filtering technique accepts all the messages and implements a software filter to later reject the unwanted message. FIG. 3 depicts one embodiment of a filter structure. Messages 14 are received at the filters 20 from the communication bus 18 and are processed to the CPU, registers, etc.

Both software and hardware filters have drawbacks. For software, the input buffers of the devices can be overloaded due to the acceptance of all the messages 14. Additionally, CPU activity may need to be supplemented. For hardware, the setting of the hardware filters can consume a great deal of time and CPU resources. The present invention proposes an embodiment comprised of both hardware and software filters. More specifically, a system and method are described to set the hardware filters in an effective manner. Although the final result may be less than optimal, the results, both in the savings of processing and time, are significantly better than the results of past techniques.

One embodiment of the present invention provides a method for optimizing communication in a network. Communication on the network involves wanted and unwanted messages wherein a set of filters are configured to accept all wanted network messages and minimize the acceptance of unwanted messages in accordance with a selection criteria. The method comprises configuring a first filter to receive all wanted messages. The first filter includes a defined bit and an undefined bit. Each defined bit is either in a first state or in a second state. A second filter is set equal to the first filter. The first filter and the second filter compose a first set of filters. Potential configurations of the first set of filters are determined wherein each potential configuration of the first set of filters is capable of accepting all wanted network messages. Each potential configuration of the first set of filters is optimized to reduce acceptance of unwanted messages while continuing to ensure acceptance of all wanted messages.

Network messages include an identifier, m, having a size of n bits, e.g., m=mₙ₋₁,mₙ₋₂, . . . m₁, m₀. M_{W} represents a set of wanted messages in the bus 18 and Mₚ represents a set of possible messages on the bus. F is a set of filters, i.e., {F₁, F₂, F₃, . . . Fᵢ} wherein Fᵢ is the ith filter, e.g., Fᵢ=fₙ₋₁, fₙ₋₁ . . . f₁, f₀; and each filter has three possible settings: match, no match, and don't care, i.e., fj={1, 0, X}.

For a filter Fᵢ, a message m will be accepted if and only if each bit, mⱼ, j=0, 1, . . . n−1; is equal to fⱼ, unless fⱼ=X, the don't care state. The equation below is shown to relate the concept that a filter be configured to accept at least all the wanted messages. That is, for (j=0, j<n, j++)

| | | |
|---|---|---|
| { | if ((fⱼ == X) or (fⱼ == mⱼ)) | {do not reject and continue} |
| | else | {reject and stop} |
| } | | |

Optimization of a single filter is expressed below in equation format. For each bit position of the filter, j, if the bits, mⱼ, of all the wanted messages, M_{W}, are identical, then set the corresponding filter components, fⱼ, to these values; else, set the value to an X, e.g., “don't care.” That is, for (j=0, j<n, j++)

| | | | |
|---|---|---|---|
| { | ∀m ε M_{w}: | | |
| | if(fⱼ == mⱼ) | {fⱼ = mⱼ} | |
| | else | {fⱼ = X} | } |

In an optimal setting for an P-filter set, i.e., F={F₁, F₂, . . . , F_{P}}, the solution comprises testing all the possible configurations of the filters and then choosing the one that incorporates the desired constraint.

One embodiment of the present invention proposes a method for configuring a two-filter set, i.e., F={F₁, F₂}. Preferably, one of the filters is initialized and configured to accept a wanted message. The single filter is then optimized and configured to accept all the wanted messages. Both filters are then set equal to each other. The first and second filter compose a first set of filters. The first set of filters is configured to accept all the wanted messages. To configure each possible configuration for the first set of filters, each filter component defined as X is alternatively defined in F1 and F₂. That is, set the X-defined component of F₁ to 0 and set the corresponding X-defined component of F₂ to 1. Then, for both F₁ and F₂, optimize each filter individually so that all wanted messages will be accepted by the two-filter set. The selected filter setting is chosen based on an application-dependent constraint, e.g., the one that minimizes the number of unwanted messages that are not rejected. The following example is provided to show the configuring of filters for a 1, 2 and 3 filter set.

M_{W} represents a set of wanted messages, i.e., M_{W}={m₁, m₂, m₃, M₄, m₅, m₆}, wherein m₁=0011 0100 1001; m₂=1010 0010 1010; m₃=1110 0001 1100; m₄=0101 0110 1000; m₅=1000 1001 1000; and m₆=0011 0101 1010.

Configuring a single filter to accept all of the wanted messages above, results in F₁=XXXX XXXX 1XXX. Thus, 2¹¹ possible messages can cross the bus. Of these messages, only 6 are wanted messages. Although there is a large amount of messages that are allowed to pass through F₁, it is still significantly less than allowing all messages to pass through, i.e. 2¹².

Utilizing the same wanted messages for the single filter example shown above, a further example is now provided for a two filter set. Preferably, the first filter, F₁, is initialized and set equal to a wanted message. F₁ is then optimized wherein its bits are set to a value that will allow F₁ to accept every wanted message. In this example, F₁=XXXX XXXX 1XXX. A second filter, F₂, is set equal to F₁, i.e., F₁=F₂=XXXX XXXX 1XXX. The filters are then configured to determine potential configurations of the first filter set, F₁ and F₂. The potential configurations for the first filter set are determined by individually replacing each X with a 0 for F₁, and a 1 for each corresponding X of F₂:

| | |
|---|---|
| 1st case: | {F₁ = 0XXX XXXX 1XXX, F₂ = 1XXX XXXX 1XXX}, |
| 2nd case: | {F₁ = X0XX XXXX 1XXX, F₂ = X1XX XXXX 1XXX}, |
| 3rd case: | {F₁ = XX0X XXXX 1XXX, F₂ = XX1X XXXX 1XXX}, |
| 4th case: | {F₁ = XXX0 XXXX 1XXX, F₂ = XXX1 XXXX 1XXX}, |
| 5th case: | {F₁ = XXXX 0XXX 1XXX, F₂ = XXXX 1XXX 1XXX}, |
| 6th case: | {F₁ = XXXX X0XX 1XXX, F₂ = XXXX X1XX 1XXX}, |
| 7th case: | {F₁ = XXXX XX0X 1XXX, F₂ = XXXX XX1X 1XXX}, |
| 8th case: | {F₁ = XXXX XXX0 1XXX, F₂ = XXXX XXX1 1XXX}, |
| 9th case: | {F₁ = XXXX XXXX 10XX, F₂ = XXXX XXXX 11XX}, |
| 10th case: | {F₁ = XXXX XXXX 1X0X, F₂ = XXXX XXXX 1X1X}, |
| 11th case: | {F₁ = XXXX XXXX 1XX0, F₂ = XXXX XXXX 1XX1}. |

In this example, there are 11 potential configurations for the first filter set. Below is a listing that shows the wanted messages accepted by each potential filter set configuration:

| | |
|---|---|
| 1st potential configuration: | {F₁ accepts (m₁, m₄, m₆), F₂ accepts (m₂, m₃, m₅)}, |
| 2nd potential configuration: | {F₁ accepts (m₁, m₂, m₅, m₆), F₂ accepts (m₃, m₄)}, |
| 3rd potential configuration: | {F₁ accepts (m₄, m₅), F₂ accepts (m₁, m₂, m₃, m₆)}, |
| 4th potential configuration: | {F₁ accepts (m₂, m₃, m₅), F₂ accepts (m₁, m₄, m₆)}, |
| 5th potential configuration: | {F₁ accepts (m₁, m₂, m₃, m₄, m₆), F₂ accepts (m₅)}, |
| 6th potential configuration: | {F₁ accepts (m₂, m₃, m₅), F₂ accepts (m₁, m₄, m₆)}, |
| 7th potential configuration: | {F₁ accepts (m₁, m₃, m₅, m₆), F₂accepts (m₂, m₄)}, |
| 8th potential configuration: | {F₁ accepts (m₁, m₂, m₄), F₂ accepts (m₃ , m₅, m₆)}, |
| 9th potential configuration: | {F₁ accepts (m₁, m₂, m₄, m₅, m₆), F₂ accepts (m₃)}, |
| 10th potential configuration: | {F₁ accepts (m₁, m₃, m₄, m₅), F₂ accepts (m₂, m₆)}, |
| 11th potential configuration: | {F₁ accepts (m₂, m₃, m₄, m₅, m₆), F₂ accepts (m₁)}. |

Each filter for each potential configuration is then separately optimized, resulting in the following potential configurations of F₁ and F₂ below:

| | |
|---|---|
| 1st potential configuration: | {F₁ = 0XX1 01XX 10XX, F₂ = 1XX0 X0XX 1XX0}, |
| 2nd potential configuration: | {F₁ = X0XX XXXX 10XX, F₂ = X1XX 0XXX 1X00}, |
| 3rd potential configuration: | {F₁ = XX0X XXXX 1000, F₂ = XX1X 0XXX 1XXX}, |
| 4th potential configuration: | {F₁ = 1XX0 X0XX 1XX0, F₂ = 01X1 0100 10XX}, |
| 5th potential configuration: | {F₁ = XXXX 0XXX 1XXX, F₂ = 1000 1001 1000}, |
| 6th potential configuration: | {F₁ = 1XX0 X0XX 1XX0, F₂ = 0XX1 01XX 10XX}, |
| 7th potential configuration: | {F₁ = XXXX XX0X 1XXX, F₂ = 0000 0X10 10X0}, |
| 8th potential configuration: | {F₁ = XXXX 0XX0 10XX, F₂ = XXXX XXX1 1XX0}, |
| 9th potential configuration: | {F₁ = XXXX XXXX 10XX, F₂ = 1110 0001 1100}, |
| 10th potential configuration: | {F₁ = XXXX XXXX 1X0X, F₂ = X01X 0XXX 1010}, |
| 11th potential configuration: | {F₁ = XXXX XXXX 1XX0, F₂ = 0011 0100 1001}. |

The number of unwanted messages accepted in each optimized case above is:

| | |
|---|---|
| 1st optimized potential configuration: | 2⁶ + 2⁶ − 6 |
| 2nd optimized potential configuration: | 2⁹ + 2⁷ − 6 |
| 3rd optimized potential configuration: | 2⁶ + 2⁹ − 6 |
| 4th optimized potential configuration: | 2⁷ + 2³ − 6 |
| 5th optimized potential configuration: | 2¹⁰ + 2⁰ − 6 |
| 6th optimized potential configuration: | 2⁷ + 2⁶ − 6 |
| 7th optimized potential configuration: | 2¹⁰ + 2² − 6 |
| 8th optimized potential configuration: | 2⁸ + 2⁹ − 6 |
| 9th optimized potential configuration: | 2¹⁰ + 2⁰ − 6 |
| 10th optimized potential configuration: | 2⁸ + 2⁵ − 6 |
| 11th optimized potential configuration: | 2¹⁰ + 2⁰ − 6 |

The optimized potential configuration for the first set of filters is chosen based on a selection criteria. One preferred selection criteria is to minimize the amount of unwanted messages allowed to pass through the first set of filters. To achieve this desired result, the 1st optimized potential configuration should be selected, i.e., {F₁=0XX1 01XX 10XX, F₂=1XX0 X0XX 1XX0}. A comparison between the filtering capability of the single filter and the dual filter set is: (2¹¹−6)/(2⁶+2⁶−6); a reduction of approximately 16 times less messages.

In addition to the selection criteria, other known information can affect the selection of the filter set to be utilized. For example, it may be known that a particular unwanted message has a higher probability of occurring over other unwanted messages. Thus, a filter set configuration should be chosen that will reject this specific unwanted message; even though in theory, the selected configuration potentially allows more unwanted messages to pass through the filter configuration.

For a three filter set configuration, i.e., F={F₁, F₂, F₃}; it is preferable to utilize the optimized two filter configuration, if available—in this example, case 1 would be utilized. However, any of the determined two filter configurations can be utilized with the third filter. Each of the 11 potential two-filter configuration cases determined earlier and shown below can be utilized with the third filter to determine a desired configuration for the three-filter set:

| | |
|---|---|
| 1st case: | {F₁ = 0XX1 01XX 10XX, F₂ = 1XX0 X0XX 1XX0}, |
| 2nd case: | {F₁ = X0XX XXXX 10XX, F₂ = X1XX 0XXX 1X00}, |
| 3rd case: | {F₁ = XX0X XXXX 1000, F₂ = XX1X 0XXX 1XXX}, |
| 4th case: | {F₁ = 1XX0 X0XX 1XX0, F₂ = 01X1 0100 10XX}, |
| 5th case: | {F₁ = XXXX 0XXX 1XXX, F₂ = 1000 1001 1000}, |
| 6th case: | {F₁ = 1XX0 X0XX 1XX0, F₂ = 0XX1 01XX 10XX}, |
| 7th case: | {F₁ = XXXX XX0X 1XXX, F₂ = 0000 0X10 10X0}, |
| 8th case: | {F₁ = XXXX 0XX0 10XX, F₂ = XXXX XXX1 1XX0}, |
| 9th case: | {F₁ = XXXX XXXX 10XX, F₂ = 1110 0001 1100}, |
| 10th case: | {F₁ = XXXX XXXX 1X0X, F₂ = X01X 0XXX 1010}, |
| 11th case: | {F₁ = XXXX XXXX 1XX0, F₂ = 0011 0100 1001}. |

Utilizing F₁ and F₂ of the selected two filter configuration, a third filter, F₃, is set equal to F₁ wherein F₁, F₂, and F₃ compose a second filter set having F₁ equal to F₃. A third filter set is also composed wherein its third filter, F₃, is set equal to the second filter, F₂; thus, the third filter set comprises F₁, F₂, and F₃ wherein F₂ and F₃ are equal.

Thus, third filter, F₃, is associated with each case wherein a second filter set and a third filter set are constructed. The second and third filter sets each comprise three filters, F₁, F₂, and F₃. F₁ and F₃ of the second filter set are set equal to each other; and F₃ is set equal to F₂ of the third filter set. Beginning with the first case, {F1=0XX1 01XX 10XX, F2=1XX0 X0XX 1XX0}, the initial configurations of the second filter set are configured by individually setting each undefined component of F₁ to 0 and each corresponding undefined filter component of F₃ to 1, respectively, as follows:

1st case, subcase1: {F₁ = 00X1 01XX 10XX, F₂ = 1XX0 X0XX 1XX0, F₃ = 01X1 01XX
10XX}
1st case, subcase2: {F₁ = 0X01 01XX 10XX, F₂ = 1XX0 X0XX 1XX0, F₃ = 0X11 01XX
10XX},
1st case, subcase3: {F₁ = 0XX1 010X 10XX, F₂ = 1XX0 X0XX 1XX0, F₃ = 0XX1 011X
10XX},
1st case, subcase4: {F₁ = 0XX1 01X0 10XX, F₂ = 1XX0 X0XX 1XX0, F₃ = 0XX1 01X1
10XX},
1st case, subcase5: {F₁ = 0XX1 01XX 100X, F₂ = 1XX0 X0XX 1XX0, F₃ = 0XX1 01XX
101X},
1st case, subcase6: {F₁ = 0XX1 01XX 10X0, F₂ = 1XX0 X0XX 1XX0, F₃ = 0XX1 01XX
10X1}.

The same is done for F1 and F3 of the third filter set:

1st case, subcase7:

{F₁ = 0XX1 01XX 10XX, F₂ = 10X0 X0XX 1XX0, F₃ = 11X0 X0XX 1XX0},

1st case, subcase8:

{F₁ = 0XX1 01XX 10XX, F₂ = 1X00 X0XX 1XX0, F₃ = 1X10 X0XX 1XX0},

1st case, subcase9:

{F₁ = 0XX1 01XX 10XX, F₂ = 1XX0 00XX 1XX0, F₃ = 1XX0 10XX 1XX0},

1st case, subcase10:

{F₁ = 0XX1 01XX 10XX, F₂ = 1XX0 X00X 1XX0, F₃ = 1XX0 X01X 1XX0},

1st case, subcase11:

{F₁ = 0XX1 01XX 10XX, F₂ = 1XX0 X0X0 1XX0, F₃ = 1XX0 X0X1 1XX0},

1st case, subcase12:

{F₁ = 0XX1 01XX 10XX, F₂ = 1XX0 X0XX 10X0, F₃ = 1XX0 X0XX 11X0},

1st case, subcase13:

{F₁ = 0XX1 01XX 10XX, F₂ = 1XX0 X0XX 1X00, F₃ = 1XX0 X0XX 1X10}.

The process continues for each subsequent case until all 11 potential filter configurations have been done. A three-filter set is then selected from all the cases and subcases determined in accordance with the selection criteria.

It is to be understood that the present invention is applicable for an P-filter set (P>3); i.e., F={F₁, F₂, . . . , F_{P}} wherein optimization of each potential filter set configuration is recursively determined via the steps shown above and the selected P-filter setting is chosen based on any constraints of the selection criteria.

While specific embodiments and exemplifications of the present invention have been illustrated and described, numerous modifications are possible without departing from the scope or spirit of the invention.

We claim:

1. A method for optimizing communication in a network, the communication involving wanted and unwanted network messages wherein a set of filters are configured to accept all wanted network messages and minimize the acceptance of unwanted messages in accordance with a selection criteria, the method comprising the steps of:
configuring a first filter to receive all wanted messages, the first filter comprising a defined bit and an undefined bit, each defined bit being either in a first state or in a second state;
setting a second filter equal to the first filter, the first filter and the second filter compose a first set of filters; and,
determining potential configurations of the first set of filters wherein each potential configuration of the first set of filters is capable of accepting all wanted network messages; and,
optimizing each potential configuration of the first set of filters.

2. The method of claim 1 further comprising the step of:
selecting an optimum configuration of the first set of filters in response to a selection criteria, the optimum configuration of the first set of filters being selected from the potential configurations of the first set of filters.

3. The method of claim 1 wherein determining potential configurations of the first set of filters comprises the steps of:
setting an undefined bit of the first filter to the first state;
setting the corresponding undefined bit of the second filter to the second state; and,
continuing to set remaining undefined bits for the first and second filter until each undefined bit of the first filter and second filter have been correspondingly defined wherein a determined potential configuration of the first set of filters exists for each initially undefined bit.

4. The method of claim 3 wherein optimizing each potential configuration of the first set of filters comprises the steps of:
filtering the wanted messages through each of the newly configured first and second filters of the first determined potential configuration,
grouping the wanted messages in response to being filtered wherein wanted messages accepted by the first filter are associated with the first filter and wanted messages accepted by the second filter are associated with the second filter;
configuring the first determined potential configuration of the first filter to accept all of the wanted messages associated with the first filter;
configuring the first determined potential configuration of the second filter to accept all of the wanted messages associated with the second filter; and,
continuing to optimize each potential configuration of the first set of filters in like manner until each potential configuration of the first set of filters has been optimized.

5. The method of claim 1 further including the step of initializing the first filter with one of the wanted network messages.

6. The method of claim 2 wherein the selection criteria includes minimizing the amount of unwanted messages passing through the first set of filters.

7. The method of claim 6 wherein the selection criteria includes prioritizing the filtering to reject a specific unwanted message.

8. The method of claim 2 further comprising the steps of:
providing a third filter for inclusion and cooperation with the selected optimum configuration of the first set of filters to facilitate communication and enhance filtering of the wanted messages throughout the network;
setting the third filter equal to the optimized first filter, the equivalent first and third filters, and second filter compose a second set of filters;
setting the third filter equal to the optimized second filter, the equivalent second and third filters and the first filter compose a third set of filters;
determining potential configurations of the second set of filters wherein each potential configuration of the second set of filters is capable of accepting all wanted network messages;
determining potential configurations of the third set of filters wherein each potential configuration of the third set of filters is capable of accepting all wanted network messages;
optimizing each potential configuration of the second set of filters; and,
optimizing each potential configuration of the third set of filters.

9. The method of claim 8 further comprising the step of:
selecting an optimum configuration among the second and third sets of filters in response to a selection criteria, the optimum configuration being selected from the potential configurations of the second and third sets of filters.

10. The method of claim 8 wherein determining potential configurations of the second set of filters comprises the steps of:
setting an undefined bit of the first filter of the second set of filters to the first state;
setting the corresponding undefined bit of the third filter of the second set of filters to the second state; and,
continuing to set remaining undefined bits for the first and third filters of the second set of filters until each undefined bit of the first filter and third filter have been correspondingly defined wherein a determined potential configuration of the second set of filters exists for each initially undefined bit.

11. The method of claim 10 wherein determining potential configurations of the third set of filters comprises the steps of:
setting an undefined bit of the second filter of the third set of filters to the first state;
setting the corresponding undefined bit of the third filter of the third set of filters to the second state; and,
continuing to define remaining undefined bits for the second and third filters of the third set of filter until each undefined bit of the second filter and third filter have been correspondingly defined wherein a determined potential configuration of the third set of filters exists for each initially undefined bit.

12. The method of claim 11 wherein optimizing each potential configuration of the second set of filters comprises the steps of:
filtering the wanted messages through the second filter of the second set of filters and the newly configured first and third filters of the first determined potential configuration of the second set of filters,
grouping the wanted messages in response to being filtered wherein wanted messages accepted by the first filter of the second set of filters are associated with the first filter of the second set of filters, wanted messages accepted by the second filter of the second set of filters are associated with the second filter of the second set of filters, and wanted messages accepted by the third filter of the second set of filters are associated with the third filter of the second set of filters;
configuring the first determined potential configuration of the first filter to accept all of the wanted messages associated with the first filter;
configuring the first determined potential configuration of the second filter to accept all of the wanted messages associated with the second filter;
configuring the first determined potential configuration of the third filter to accept all of the wanted messages associated with the third filter; and,
continuing to optimize each potential configuration of the second set of filters until each potential configuration of the second set of filters has been optimized.

13. The method of claim 12 wherein optimizing each potential configuration of the third set of filters comprises the steps of:
filtering the wanted messages through the first filter of the third set of filters and the newly configured second and third filters of the first determined potential configuration of the third set of filters,
grouping the wanted messages in response to being filtered wherein wanted messages accepted by the first filter of the third set of filters are associated with the first filter of the third set of filters, wanted messages accepted by the second filter of the third set of filters are associated with the second filter of the third set of filters, and wanted messages accepted by the third filter of the third set of filters are associated with the third filter of the third set of filters;
configuring the first determined potential configuration of the first filter of the third set of filters to accept all of the wanted messages associated with the first filter of the third set of filters;
configuring the first determined potential configuration of the second filter of the third set of filters to accept all of the wanted messages associated with the second filter of the third set of filters;
configuring the first determined potential configuration of the third filter of the third set of filters to accept all of the wanted messages associated with the third filter of the third set of filters; and,
continuing to optimize each potential configuration of the third set of filters until each potential configuration of the third set of filters has been optimized.

14. The method of claim 9 wherein the selection criteria includes minimizing the amount of unwanted messages passing through the selected optimum configuration among the second and third sets of filters.

15. The method of claim 14 wherein the selection criteria includes prioritizing the filtering to reject a specific unwanted message.

16. The method of claim 2 further comprising the steps of:
providing a third filter for inclusion and cooperation with each of the determined potential configurations of the first set of filters to facilitate communication and enhance filtering of the wanted messages throughout the network;
setting the third filter equal to the first filter of a first determined potential configuration of the first set of filters, the equivalent first and third filters, and second filter compose a second set of filters;
setting the third filter equal to the second filter of the first determined potential configuration of the first set of filters, the equivalent second and third filters, and the first filter compose a third set of filters;
determining potential configurations of the second set of filters wherein each potential configuration of the second set of filters is capable of accepting all wanted network messages;
determining potential configurations of the third set of filters wherein each potential configuration of the third set of filters is capable of accepting all wanted network messages;
optimizing each potential configuration of the second set of filters; and,
optimizing each potential configuration of the third set of filters.

17. The method of claim 16 further comprising the step of:
selecting a filter configuration among the second and third sets of filters in response to a selection criteria, the filter configuration being selected from the potential configurations of the second and third sets of filters.

18. The method of claim 16 wherein determining potential configurations of the second set of filters comprises the steps of:
setting an undefined bit of the first filter of the second set of filters to the first state;
setting the corresponding undefined bit of the third filter of the second set of filters to the second state; and,
continuing to set remaining undefined bits for the first and third filters of the second set of filters until each undefined bit of the first filter and third filter of the second set of filters has been correspondingly defined wherein a determined potential configuration of the second set of filters exists for each initially undefined bit.

19. The method of claim 16 wherein determining potential configurations of the third set of filters comprises the steps of:
setting an undefined bit of the second filter of the third set of filters to the first state;
setting the corresponding undefined bit of the third filter of the third set of filters to the second state; and,
continuing to set remaining undefined bits for the second and third filters of the third set of filters until each undefined bit of the second filter and third filter have been correspondingly defined wherein a determined potential configuration of the third set of filters exists for each initially undefined bit.

20. The method of claim 16 wherein optimizing each potential configuration of the second set of filters comprises the steps of:
filtering the wanted messages through the second filter and the newly configured first and third filters of the first determined potential configuration of the second set of filters,
grouping the wanted messages in response to being filtered wherein wanted messages accepted by the first filter of the second set of filters are associated with the first filter, wanted messages accepted by the second filter of the second set of filters are associated with the second filter, and wanted messages accepted by the third filter of the second set of filters are associated with the third filter;
configuring the first determined potential configuration of the first filter to accept all of the wanted messages associated with the first filter;
configuring the first determined potential configuration of the second filter to accept all of the wanted messages associated with the second filter;
configuring the first determined potential configuration of the third filter to accept all of the wanted messages associated with the third filter; and,
continuing to optimize each potential configuration of the second set of filters until each potential configuration of the second set of filters has been optimized.

21. The method of claim 12 wherein optimizing each potential configuration of the third set of filters comprises the steps of:
filtering the wanted messages through the first filter and the newly configured second and third filters of the first determined potential configuration of the third set of filters;
grouping the wanted messages in response to being filtered wherein wanted messages accepted by the first filter are associated with the first filter, wanted messages accepted by the second filter are associated with the second filter, and wanted messages accepted by the third filter are associated with the third filter;
configuring the first determined potential configuration of the first filter to accept all of the wanted messages associated with the first filter;
configuring the first determined potential configuration of the second filter to accept all of the wanted messages associated with the second filter;
configuring the first determined potential configuration of the third filter to accept all of the wanted messages associated with the third filter; and,
continuing to optimize each potential configuration of the third set of filters until each potential configuration of the third set of filters has been optimized.

22. The method of claim 9 wherein the selection criteria includes minimizing the amount of unwanted messages passing through the selected optimum configuration among the second and third sets of filters.

23. The method of claim 14 wherein the selection criteria includes prioritizing the filtering to reject a specific unwanted message.

24. A computer readable medium for optimizing communication in a network, the communication involving wanted and unwanted network messages wherein a set of filters are configured to accept all wanted network messages and minimize the acceptance of unwanted messages in accordance with a selection criteria, the computer readable medium comprising:
a first segment for configuring a first filter to receive all wanted messages, the first filter comprising a defined bit and an undefined bit, each defined bit being either in a first state or in a second state;
a second segment for setting a second filter equal to the first filter, the first filter and the second filter compose a first set of filters; and,
a third segment for determining potential configurations of the first set of filters wherein each potential configuration of the first set of filters is capable of accepting all wanted network messages; and,
a fourth segment for optimizing each potential configuration of the first set of filters.

25. The computer readable medium of claim 24 further comprising the step of:
a fifth segment for selecting an optimum configuration of the first set of filters in response to a selection criteria, the optimum configuration of the first set of filters being selected from the potential configurations of the first set of filters.

26. The computer readable medium of claim 24 wherein determining potential configurations of the first set of filters comprises the steps of:
a sixth segment for setting an undefined bit of the first filter to the first state;
a seventh segment for setting the corresponding undefined bit of the second filter to the second state; and,
an eighth segment for continuing to define remaining undefined bits for the first and second filter in like manner until each undefined bit of the first filter and second filter has been correspondingly defined wherein a determined potential configuration of the first set of filters exists for each initially undefined bit.

27. The computer readable medium of claim 24 wherein optimizing each potential configuration of the first set of filters comprises:
a ninth segment filtering the wanted messages through each of the newly configured first and second filters of the first determined potential configuration, a tenth segment for grouping the wanted messages in response to being filtered wherein wanted messages accepted by the first filter are associated with the first filter and wanted messages accepted by the second filter are associated with the second filter;
an eleventh segment for configuring the first determined potential configuration of the first filter to accept all of the wanted messages associated with the first filter;
a twelfth segment for configuring the first determined potential configuration of the second filter to accept all of the wanted messages associated with the second filter; and,
a thirteenth segment for optimizing each potential configuration of the first set of filters wherein the optimizing continues until each potential configuration of the first set of filters has been optimized.

28. The medium of claim 24 wherein the selection criteria includes minimizing the amount of unwanted messages passing through the first set of filters.

29. The medium of claim 26 wherein the selection criteria includes prioritizing the filtering to reject a specific unwanted message.
